(19) United States
(12) Patent Application Publication
(10) Pub. No.: US 2026/0031252 A1
(43) Pub. Date: Jan. 29, 2026

(54) Photoelectric Composite Flexible High-Voltage Reel Cable

(71) Applicant: ZHONGCHEN CABLE (JIANGXI) CO., LTD, Yingtan (CN)

(72) Inventors: Qifa XU, Yingtan (CN); Nanping DU, Yingtan (CN); Cailiang PING, Jiangxi (CN); Wenhao JIANG, Yingtan (CN)

(21) Appl. No.: 18/995,119

(22) PCT Filed: Oct. 17, 2024
(86) PCT No.: PCT/CN2024/073667

§ 371 Date: Jan. 15, 2025

(30) Foreign Application Priority Data
Apr. 11, 2023 (CN) 202310377545.3

(51) Int. Cl. H01B 7/20; H01B 7/18; H01B 7/282; H01B 7/42

(52) U.S. Cl. CPC H01B 7/207; H01B 7/1875; H01B 7/282; H01B 7/421

(57) ABSTRACT

A photoelectric composite flexible high-voltage reel cable, including a polyethylene outer sheath (1), a double-face plastic-coated steel belt (2) connected to an inner side of the polyethylene outer sheath (1), an insulating tape (3) connected to an inner side of the double-face plastic-coated steel belt (2), an anti-crack protective sleeve (4) connected to an inner side of the insulating tape (3), and a power cord body (6), a filler rope (7), a reinforcement (9) and an optical fiber body (8) sequentially distributed on an inner side of the anti-crack protective sleeve (4) from top to bottom, where the power cord body (6), the filler rope (7) and the optical fiber body (8) are distributed on a peripheral side of the reinforcement (9). The photoelectric composite flexible high-voltage reel cable further includes a metal radiating column (11), movable balls (13), a rubber air bag (14), and a conveying pipe (15).

### CROSS-REFERENCE TO RELATED APPLICATION

This application is a national stage application of International Patent Application No. PCT/CN2024/073667, filed on Jan. 23, 2024, which claims priority of Chinese Patent Application No. 202310377545.3 filed with the China National Intellectual Property Administration on Apr. 11, 2023. The disclosure of the two applications is incorporated herein by reference in its entirety as part of the present application

### TECHNICAL FIELD

The present disclosure relates to the technical field of cables, and in particular to a photoelectric composite flexible high-voltage reel cable.

### BACKGROUND

Cable is a device that is composed of several wires or groups of wires, and is capable of transmitting electric energy or signals, which could be used in suburban areas, rural areas, main lines of users, switch cabinets and other places, and is mainly used for transmission of the electric energy in power generation lines, distribution lines, transmission lines, substation lines and power supply lines. The cable has a wide range of varieties and specifications, and the cable with corresponding performance could be provided according to an use place. In order to ensure long-distance transmission of the electric power and safety of electric power transmission, the cable is generally assembled in high altitude outdoor.

Chinese patent with publication number CN218497810U discloses a photoelectric composite flexible high-voltage reel cable for port power supply, including a semi-conductive filler strip, a power line core, a ground wire core, and a signal wire core. The power line core, the ground wire core and the signal wire core are stranded and distributed on a peripheral side of the semi-conductive filler strip, parallel arrangement of cable core structures greatly reduces an overall external diameter of the cable, saves cost of a reel device, and improves overall shielding performance of the cable. Moreover, the semi-conductive filler strip is made of a vulcanized rubber strip, which could absorb impact energy in a radial direction of the cable better, and could support the power line core, the ground wire core and the signal wire core, thus protecting wire cores inside the cable. The semi-conductive filler strip could improve tensile strength of the cable, and cooperates with a reinforced layer of a Kevlar silk mesh structure to make the cable bear greater axial load.

Chinese patent with publication number CN209880238U discloses a cable, including a PVC (polyvinyl chloride) sheath layer, a reinforcing layer and multiple wire cores sequentially from outside to inside. The multiple wire cores include a middle core wire, and side core wires annularly arranged along an outer side of the middle core wire. The middle core wire includes multiple conductive wires, and an insulating layer covering the conductive wires. A limiting strip for positioning the side core wire is arranged on an outer side of the insulating layer, and a limiting groove to be clamped with the limiting strip is arranged on an outer side of the side core wire. The utility model has characteristics of good compression resistance and elasticity, and through clamping and positioning of the side core wire and the middle core wire, the side core wire is ensured not to be displaced in coating process, uniformity of the cable core wire in a circumferential direction is improved, and force on each part of the cable is ensured to be uniform.

The cable in the prior art is composed of various layers, thus achieving buffering of the cable and improving bearing capacity of the cable. During power transmission, heat is generated in the cable, leading to the increase of internal heat of the cable. Due to the increase of cores and protective layers inside the cable, a heating speed of the cable will be reduced, and the increase of cumulative heat in the cable will affect the service life of the cable.

Therefore, a photoelectric composite flexible high-voltage reel cable is provided to solve the problems above.

### SUMMARY

An object of the present disclosure is to provide a photoelectric composite flexible high-voltage reel cable to solve the problems as follows in the background: the cable in the market is composed of various layers, thus achieving buffering of the cable and improving bearing capacity of the cable; but during power transmission, heat is generated in the cable, leading to increase of internal heat of the cable; and due to the increase of cores and protective layers inside the cable, a heating speed of the cable will be reduced, and the increase of cumulative heat in the cable will affect the service life of the cable.

To achieve the object above, the present disclosure provides the following technical solutions.

A photoelectric composite flexible high-voltage reel cable, including a polyethylene outer sheath, a double-face plastic-coated steel belt connected to an inner side of the polyethylene outer sheath, an insulating tape connected to an inner side of the double-face plastic-coated steel belt, an anti-crack protective sleeve connected to an inner side of the insulating tape, and a power cord body, a filler rope, a reinforcement and an optical fiber body sequentially distributed on an inner side of the anti-crack protective sleeve from top to bottom,
where the photoelectric composite flexible high-voltage reel cable further includes:
the power cord body, the filler rope and the optical fiber body, which are distributed on a peripheral side of the reinforcement;
an inner filling groove, arranged inside the anti-crack protective sleeve, where an inner flexible protective sleeve is connected to a middle part of the inner filling groove, an outer arc groove is arranged on an outer side of the inner flexible protective sleeve, the power cord body, the filler rope and the optical fiber body are attached to an outer side of the outer arc groove, and the reinforcement attachedly penetrates through an middle part of the inner flexible protective sleeve;
a metal radiating column, which penetrates through the polyethylene outer sheath, the double-face plastic-coated steel belt, the insulating tape, and the anti-crack protective sleeve in sequence;
a movable groove, arranged inside the polyethylene outer sheath, where a rubber air bag is bonded an side inside the movable groove, an other side inside the movable groove is filled with movable balls, an side of the rubber air bag communicates with a conveying pipe, and an other end of the conveying pipe communicates with the metal radiating column; and
a mounting groove, arranged inside the double-face plastic-coated steel belt, where the conveying pipe penetrates attachedly through inside the mounting groove.

In some embodiments, the power cord body includes an outer power cord rubber sheath and inner power cord cores; and the inner power cord cores are distributed in the outer power cord rubber sheath. Such a design could achieve the protection of the power cord body.

In some embodiments, the optical fiber body includes an outer optical fiber rubber sheath and inner optical fiber cores; and the inner optical fiber cores are distributed in the outer optical fiber rubber sheath. Such a design could achieve the protection of an optical fiber.

In some embodiments, the anti-crack protective sleeve is made of a wire net material, thus preventing the photoelectric composite flexible high-voltage reel cable from being broken due to hanging stress.

In some embodiments, the power cord body, the filler rope and the optical fiber body are distributed between the inner filling groove and the inner flexible protective sleeve; the power cord body, the filler rope, the optical fiber body and the reinforcement are separately assembled by the inner flexible protective sleeve; and the inner filling groove is filled with flexible particles inside. Such a design could flexibly protect the cable by using the flexible particles in the inner filling groove and the inner flexible protective sleeve, thus preventing the power cord body, the filler rope, the optical fiber body and the reinforcement therein from being worn due to mutual collision.

In some embodiments, one end of the metal radiating column with a hollow structure inside extends into the inner filling groove, and an other end of the metal radiating column penetrates through the polyethylene outer sheath; and the one end, extending into the inner filling groove, of the metal radiating column is of a closed structure, and the other end of the metal radiating column is of an open structure. Such a design could radiate the cable by using the metal radiating column, thus preventing water vapor from entering the cable.

In some embodiments, the movable groove is of an arc structure, and the movable grooves are distributed in the polyethylene outer sheath at equal angles.

In some embodiments, the rubber air bag and the metal radiating column communicate with each other through the conveying pipe, and the conveying pipe is of an arc structure. Such a design could convey airflow in the rubber air bag into the metal radiating column to accelerate a radiating speed of the metal radiating column.

In some embodiments, an outer surface of each of the movable balls is of a smooth structure, and the movable balls are able to roll in the movable groove. Through such a design, rolling of the movable ball could be used to squeeze the rubber air bag, thus conveying the airflow.

Compared with the prior art, some embodiments of the present disclosure have the following beneficial effects.
(1) A photoelectric composite flexible high voltage reel cable is provided with an inner flexible protective sleeve, and an inner filling groove filled with flexible particles. The inner flexible protective sleeve is used to separate a power cord body, a filler rope, an optical fiber body, and a reinforcement, thus preventing the power cord body, the filler rope, the optical fiber body and the reinforcement from being worn due to force collision, and buffering a shaking force on the cable. With the cooperation of activities of the flexible particles in the inner filling groove, clastic buffering could be rapidly carried out to achieve flexible protection of the cable.
(2) The photoelectric composite flexible high-voltage reel cable is provided with a hollow metal radiating column, which could be used for radiating of the cable. When the cable is shaken by the wind at high altitude, movable balls squeeze the rubber air bag repeatedly, such that the rubber air bag could suck air and blow air through a conveying pipe and the metal radiating column, and a flow of air in the metal radiating column could accelerate a radiating speed of the metal radiating column, thereby accelerating the radiating of the cable.
(3) For the photoelectric composite flexible high-voltage reel cable, one end, extending into the inner filling groove, of the metal radiating column is of a closed structure, and the other end, extending to the outside, of the metal radiating column is of an open structure. With blocking of the metal radiating column with a closed lower end and the rubber air bag, rainwater is prevented from entering the cable. Due to the action of an airflow, the rainwater could be ejected from the metal radiating column. Moreover, heat conduction of the metal radiating column and irradiation of the sun in clear weather could evaporate moisture in the metal radiating column, which not only ensures the rapid radiation of the heat of the cable, but also could prevent the moisture from entering the cable.

### BRIEF DESCRIPTION OF THE DRAWINGS

FIG. 1 shows a schematic diagram of an overall structure according to an embodiment of the present disclosure;

FIG. 2 shows a schematic diagram of a three-dimensional structure of an anti-crack protective sleeve according to an embodiment of the present disclosure;

FIG. 3 shows a schematic diagram of a sectional structure according to an embodiment of the present disclosure;

FIG. 4 shows a schematic diagram of an enlarged structure of position A in FIG. 3 of the present disclosure;

FIG. 5 shows a schematic diagram of a sectional structure of a polyethylene outer sheath according to an embodiment of the present disclosure;

FIG. 6 shows a schematic diagram of a three-dimensional structure of an inner flexible protective sleeve according to an embodiment of the present disclosure;

FIG. 7 shows a schematic diagram of a three-dimensional structure of a rubber air bag according to an embodiment of the present disclosure; and

FIG. 8 shows a schematic diagram of a three-dimensional structure of a conveying pipe according to an embodiment of the present disclosure.

In the drawings: 1 refers to a polyethylene outer sheath; 2 refers to a double-face plastic-coated steel belt; 3 refers to an insulating tape; 4 refers to an anti-crack protective sleeve; 5 refers to an inner filling groove; 6 refers to a power cord body; 601 refers to an outer power cord rubber sheath; 602 refers to an inner power cord core; 7 refers to a filler rope; 8 refers to an optical fiber body; 801 refers to an outer optical fiber rubber sheath; 802 refers to an inner optical fiber core; 9 refers to a reinforcement; 10 refers to an inner flexible protective sleeve; 11 refers to a metal radiating column; 12 refers to a movable groove; 13 refers to a movable ball; 14 refers to a rubber air bag; 15 refers to a conveying pipe; 16 refers to a mounting groove; and 17 refers to an outer arc groove.

### DETAILED DESCRIPTION OF THE EMBODIMENTS

The following clearly and completely describes the technical solutions in examples of the present disclosure with reference to the drawings in the embodiments of the present disclosure. Apparently, the described examples are merely a part rather than all of the embodiments of the present disclosure. All other embodiments obtained by a person of ordinary skill in the art based on the examples of the present disclosure without creative efforts shall fall within the scope of the present disclosure.

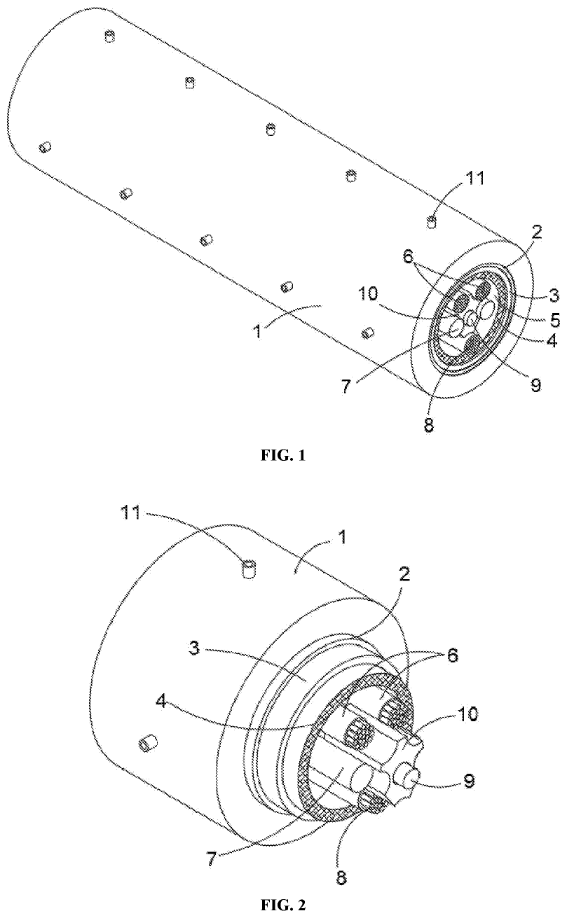

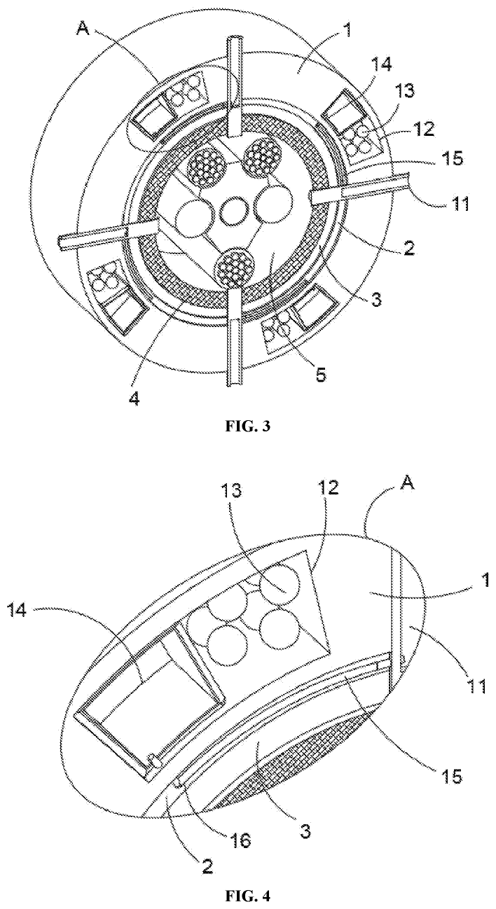

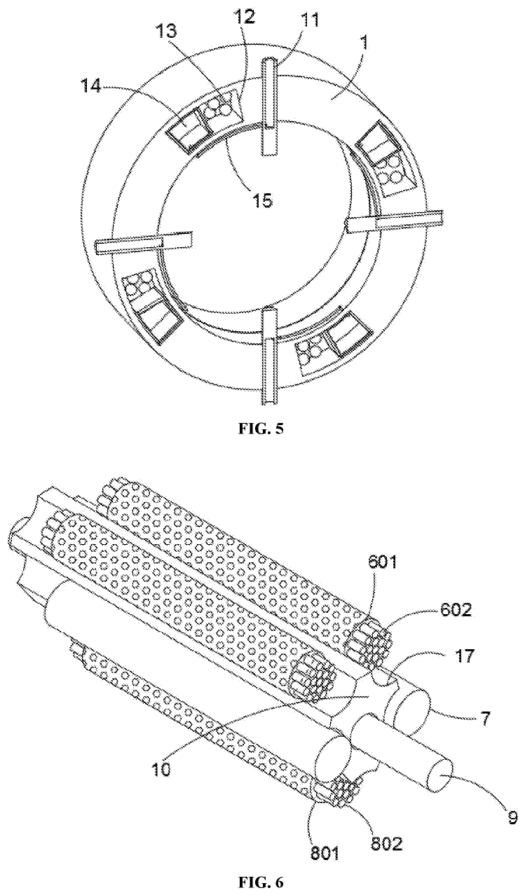

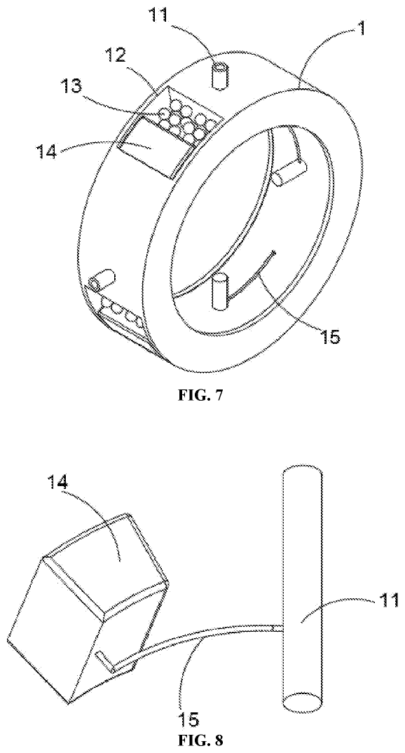

Please refer to FIG. 1 to FIG. 8, the present disclosure provides the following technical solutions: a photoelectric composite flexible high-voltage reel cable.

### Example 1

Direct use of a fixed flexible layer has a single buffering mode for external force, and could not cooperate with a movable flexible buffering mechanism for rapid force release. Therefore, in order to solve this technical problem, this example also includes a polyethylene outer sheath 1, a double-face plastic-coated steel belt 2 connected to an inner side of the polyethylene outer sheath 1, an insulating tape 3 connected to an inner side of the double-face plastic-coated steel belt 2, an anti-crack protective sleeve 4 connected to an inner side of the insulating tape 3, and a power cord body 6, a filler rope 7, a reinforcement 9 and an optical fiber body 8 sequentially distributed on an inner side of the anti-crack protective sleeve 4 from top to bottom, where the power cord body 6, the filler rope 7 and the optical fiber body 8 are distributed on a peripheral side of the reinforcement 9; an inner filling groove 5 arranged inside the anti-crack protective sleeve 4, where an inner flexible protective sleeve 10 is connected to a middle part of the inner filling groove 5, an outer arc groove 17 is arranged on an outer side of the inner flexible protective sleeve 10, and the power cord body 6, the filler rope 7 and the optical fiber body 8 are attached to the outer side of the outer arc groove 17; and the reinforcement 9 penetrates through an middle part of the inner flexible protective sleeve 10 in an attached manner.

The power cord body 6 includes an outer power cord rubber sheath 601, and inner power cord cores 602; and the inner power cord cores 602 are distributed in the outer power cord rubber sheath 601. The optical fiber body 8 includes an outer optical fiber rubber sheath 801, and inner optical fiber cores 802; and the inner optical fiber cores 802 are distributed in the outer optical fiber rubber sheath 801. The anti-crack protective sleeve 4 is made of a wire net material, thus preventing the cable from being broken due to hanging stress. The power cord body 6, the filler rope 7 and the optical fiber body 8 are distributed between the inner filling groove 5 and the inner flexible protective sleeve 10. The power cord body 6, the filler rope 7, the optical fiber body 8 and the reinforcement 9 are separately assembled by the inner flexible protective sleeve 10, and the filling groove 5 is filled with flexible particles inside.

Operation principle of this example is as follows: during aerial working of the cable, the polyethylene outer sheath 1, the double-face plastic-coated steel belt 2, the insulating tape 3, the anti-crack protective sleeve 4, the power cord body 6, the filler rope 7, the optical fiber body 8 and the reinforcement 9 integrally form a cable. The cable is protected and insulated by the polyethylene outer sheath 1, the double-face plastic-coated steel belt 2 and the insulating tape 3. The anti-crack protective sleeve 4 is made of a wire net material, which could improve the tensile and fracture resistance of the cable, and prevent the cable from breaking due to hanging stress. The power cord body 6, the filler rope 7, the optical fiber body 8 and the reinforcement 9 are protected and assembled in the inner filling groove 5 by the polyethylene outer sheath 1, the double-face plastic-coated steel belt 2, the insulating tape 3 and the anti-crack protective sleeve 4. The inner flexible protective sleeve 10 is installed between the power cord body 6, the filler rope 7, the optical fiber body 8 and the reinforcement 9. The inner flexible protective sleeve 10 is used to separate the power cord body 6, the filler rope 7, the optical fiber body 8 and the reinforcement 9, thus preventing the power cord body 6, the filler rope 7, the optical fiber body 8 and the reinforcement 9 from being worn due to force collision. The inner flexible protective sleeve 10 is used to buffer shaking force on the cable, the filler rope 7 could further buffer overall force of the cable, while the reinforcement 9 could enhance firmness of the overall cable. The inner filling groove 5 is filled with flexible particles. When force is applied, the flexible particles could play a role of elastically buffering and move in the inner filling groove 5 to protect the cable further flexibly. The power cord body 6 includes a mesh-like outer power cord rubber sheath 601 and an inner power cord core 602, thus reducing wear of the power cord body 6. The optical fiber body 8 includes a mesh-like outer optical fiber rubber sheath 801 and an inner optical fiber core 802, thus reducing the wear of the optical fiber body 8 and improving overall safety protection performance of the cable.

### Example 2

During power transmission, heat is generated in a cable, leading to the increase of internal heat of the cable; and due to the increase of cores and protective layers inside the cable, a heating speed of the cable will be reduced, and the increase of cumulative heat in the cable will affect the service life of the cable. Therefore, in order to solve this technical problem, this example also includes a metal heat dissipation column 11, a movable groove 12, and a mounting groove 16. The metal heat dissipation column 11 penetrates through the polyethylene outer sheath 1, the double-face plastic-coated steel belt 2, the insulating tape 3, and the anti-crack protective sleeve 4 in sequence. The movable groove 12 is arranged inside the polyethylene outer sheath 1, a rubber air bag 14 is bonded inside the movable groove 12, and the other side of the movable groove 12 is filled with movable balls 13. One side of the rubber air bag 14 communicates with a conveying pipe 15, and an other end of the conveying pipe 15 communicates with the metal radiating column 11. The mounting groove 16 is arranged in the double-face plastic-coated steel belt 2, and the conveying pipe 15 penetrates through the inside of the mounting groove 16 in an attached manner.

One end of the metal radiating column 11 with a hollow structure inside extendes into the inner filling groove 5, and the other end of the metal radiating column 11 penetrates through the polyethylene outer sheath 1. One end, extending into the inner filling groove 5, of the metal radiating column 11 is of a closed structure, and the other end of the metal radiating column is of an open structure. The movable groove 12 is of an arc structure, and the movable grooves 12 are distributed in the polyethylene outer sheath 1 at equal angles. The rubber air bag 14 and the metal radiating column 11 communicates with each other through the conveying pipe 15, and the conveying pipe 15 is of an arc structure. An outer surface of each of the movable balls 13 is of a smooth structure, and the movable balls 13 are able to roll in the movable groove 12.

Operation principle of this example is as follows: the metal radiating column 11 could radiate the cable, and the cable shakes due to the wind at high-altitude, and the movable ball 13 in the movable groove 12 rolls. When the movable ball 13 rolls to squeeze the rubber air bag 14, an airflow in the rubber air bag 14 is conveyed into the metal radiating column 11 through the conveying pipe 15. When the airflow is discharged to the outside, and the movable ball 13 rolls to release a squeeze to the rubber air bag 14, the rubber air bag 14 could be reset and swelled, an external airflow enters the rubber air bag 14 along with the metal radiating column 11 and the conveying pipe 15, and a radiating speed of the metal radiating column 11 could be accelerated with a flow of air, thus accelerating radiating of the cable. On rainy days, due to blockage of the metal radiating column 11 with the closed lower end and the rubber air bag 14, rainwater is prevented from entering the cable, and when the airflow is pushed out, the rain water could be ejected from the metal radiating column 11 due to an action of the airflow. Moreover, heat conduction of the metal radiating column 11 and irradiation of the sun in clear weather could evaporate moisture in the metal radiating column, which not only ensures rapid radiation of the heat of the cable, but also could prevent the moisture from entering the cable.

Contents that are not described in detail in this specification belong to the prior art known to the those skilled in the art.

In the description of the present disclosure, unless otherwise specifically specified, “a plurality of” means two or more. Orientation or positional relationship indicated by terms “upper”, “lower”, “left”, “right”, “inside”, “outside”, “front end”, “rear end”, “head” and “tail” is based on the orientation or positional relationship shown in the drawings only for convenience of description of the present disclosure and simplification of description rather than indicating or implying that apparatus or element referred to must have a particular orientation, be constructed and operate in a particular orientation, and thus are not to be construed as limiting the present disclosure. Furthermore, terms “first”, “second” and “third” are used for descriptive purposes only and are not to be construed as indicating or implying relative importance.

In the present disclosure, it should be noted that, unless expressly specified and limited otherwise, terms “couple” and “connect” should be understood broadly, e.g., may be a fixed connection, a detachable connection, or an integrated connection; may be a mechanical connection, or an electrical connection; may be a direct connection, or an indirect connection through an intermediate medium. For those of ordinary skill in the art, specific meanings of the above terms in the present disclosure could be understood on a case-by-case basis.

Finally, although the present disclosure is described in detail with reference to above embodiments, those skilled in the art can still modify the technical solutions described in the above embodiments, or make equivalent substitutions for some technical features therein. Any modification, equivalent replacement, improvement, etc. made within the spirit and principle of the present disclosure should be included in the scope of the present disclosure.

1. A photoelectric composite flexible high-voltage reel cable, comprising:
a polyethylene outer sheath (1);
a double-face plastic-coated steel belt (2) connected to an inner side of the polyethylene outer sheath (1);
an insulating tape (3) connected to an inner side of the double-face plastic-coated steel belt (2);
an anti-crack protective sleeve (4) connected to an inner side of the insulating tape (3); and
a power cord body (6), a filler rope (7), a reinforcement (9) and an optical fiber body (8) sequentially distributed on an inner side of the anti-crack protective sleeve (4) from top to bottom, wherein the power cord body (6), the filler rope (7) and the optical fiber body (8) are distributed on a peripheral side of the reinforcement (9);
wherein the photoelectric composite flexible high-voltage reel cable further comprises:
an inner filling groove (5), arranged inside the anti-crack protective sleeve (4), wherein an inner flexible protective sleeve (10) is connected to a middle part of the inner filling groove (5), an outer arc groove (17) is arranged on an outer side of the inner flexible protective sleeve (10), the power cord body (6), the filler rope (7) and the optical fiber body (8) are attached to an outer side of the outer arc groove (17), and the reinforcement (9) attachedly penetrates through an middle part of the inner flexible protective sleeve (10);
a metal radiating column (11), which penetrates through the polyethylene outer sheath (1), the double-face plastic-coated steel belt (2), the insulating tape (3), and the anti-crack protective sleeve (4) in sequence;
a movable groove (12), arranged inside the polyethylene outer sheath (1), wherein a rubber air bag (14) is bonded an side inside the movable groove (12), an other side inside the movable groove (12) is filled with movable balls (13), an side of the rubber air bag (14) communicates with a conveying pipe (15), and an other end of the conveying pipe (15) communicates with the metal radiating column (11); and
a mounting groove (16), arranged inside the double-face plastic-coated steel belt (2), wherein the conveying pipe (15) attachedly penetrates through inside the mounting groove (16).

2. The photoelectric composite flexible high-voltage reel cable of claim 1, wherein the power cord body (6) comprises an outer power cord rubber sheath (601) and inner power cord cores (602); and
the inner power cord cores (602) are distributed in the outer power cord rubber sheath (601).

3. The photoelectric composite flexible high-voltage reel cable of claim 1, wherein the optical fiber body (8) comprises an outer optical fiber rubber sheath (801) and inner optical fiber cores (802); and
the inner optical fiber cores (802) are distributed in the outer optical fiber rubber sheath (801).

4. The photoelectric composite flexible high-voltage reel cable of claim 1, wherein the anti-crack protective sleeve (4) is made of a wire net material.

5. The photoelectric composite flexible high-voltage reel cable of claim 1, wherein the power cord body (6), the filler rope (7) and the optical fiber body (8) are distributed between the inner filling groove (5) and the inner flexible protective sleeve (10);
the power cord body (6), the filler rope (7), the optical fiber body (8) and the reinforcement (9) are separately assembled by the inner flexible protective sleeve (10); and
the inner filling groove (5) is filled with flexible particles inside.

6. The photoelectric composite flexible high-voltage reel cable of claim 1, wherein one end of the metal radiating column (11) with a hollow structure inside extends into the inner filling groove (5), and an other end of the metal radiating column (11) penetrates through the polyethylene outer sheath (1); and
the one end, extending into the inner filling groove (5), of the metal radiating column (11) is of a closed structure, and the other end of the metal radiating column (11) is of an open structure.

7. The photoelectric composite flexible high-voltage reel cable of claim 1, wherein the movable groove (12) is of an arc structure, and the movable grooves (12) are distributed in the polyethylene outer sheath (1) at equal angles.

8. The photoelectric composite flexible high-voltage reel cable of claim 1, wherein the rubber air bag (14) and the metal radiating column (11) communicate with each other through the conveying pipe (15), and
the conveying pipe (15) is of an arc structure.

9. The photoelectric composite flexible high-voltage reel cable of claim 1. wherein an outer surface of each of the movable balls (13) is of a smooth structure, and
the movable balls (13) roll in the movable groove (12).
